(19) United States
(12) Patent Application Publication
(10) Pub. No.: US 2012/0264420 A1
(43) Pub. Date: Oct. 18, 2012

(54) DISTRIBUTED BASE STATION CONTROLLER

(76) Inventor: Terry L. WILLIAMS, Melbourne Beach, FL (US)

(21) Appl. No.: 13/536,089

(22) Filed: Jun. 28, 2012

Related U.S. Application Data
(62) Division of application No. 11/344,890, filed on Feb. 1, 2006.

(51) Int. Cl. H04W 24/04; H04W 72/04; H04W 36/08

(52) U.S. Cl. 455/423; 455/436

(57) ABSTRACT

A wireless cellular telecommunication system with an internet protocol network is provided. The wireless cellular telecommunication system comprises one or more base transceiver stations. The base transceiver stations can selectively provide a radio resource management processing. The radio resource management processing can provide a means for performing an inter-base transceiver station handover. A base transceiver station can communicate with another base transceiver station for the radio resource management processing without assistance from a centralized controller to perform control processing for the base transceiver stations. The base transceiver stations can further selectively provide a radio resource management processing, such as allocating a radio channel, deallocating a radio channel, changing a radio channel, or activating ciphering, without the assistance from a centralized controller to perform control processing for the base transceiver stations.

### INCORPORATION BY REFERENCE

The present application is a divisional application of U.S. application Ser. No. 11/344,890, filed Feb. 1, 2006, the entire disclosure of which is incorporated herein by reference.

### BACKGROUND OF THE INVENTION

1. Statement of the Technical Field

The invention concerns wireless communications equipment, and more particularly, GSM wireless communication systems with a distributed base station controller.

2. Description of the Related Art

A traditional GSM based wireless communications system architecture typically includes several functional entities, such as a mobile station, a base station subsystem, and a network switching subsystem. The base station subsystem typically includes one or more base transceiver stations and a base station controller. The base transceiver stations are comprised of radio transceivers. The radio transceivers typically contain hardware and software for processing a signal with radio-link protocols sent to and from a mobile station.

The base station controller typically is a centralized controller to perform control processing for one or more base transceiver stations. The base station controller's control processing typically includes radio resource management. The management of radio resources typically includes controlling two or more hardware entities for coordinating radio communications. The hardware entities typically include a mobile station, a base transceiver station, a centralized base station controller, and a mobile service switching center. A radio resource management function typically includes allocating a radio channel to a mobile station, deallocating a radio channel to a mobile station, and activating ciphering within a mobile station. For example, a base station controller typically allocates a radio channel to a mobile station for providing a connection between the mobile station and a base transceiver station. Radio resource management also typically includes intra-base station controller handover management. Specifically, the management function includes the processing of signals from a mobile station and the originating base station for the determination of when a handover is necessary and selection of the target base station to where the handover is to occur. Radio resource management also includes the coordination of signaling between the originating and target base stations when performing handover from one base transceiver station to another base transceiver station.

The centralized base station controller must be capable of managing a large processing load to support a large number of base transceiver stations. One problem with existing base station controllers is that they are not easily scalable to accommodate system growth. Moreover, existing base station controllers must be designed for a high degree of fault tolerance as they are a potential single point of system failure.

Fixed and mobile communication providers are trying to provide a wireless communications system that offers a greater degree of scalability. To provide a scaleable wireless communications system, alternative wireless communications system architectures are needed.

### SUMMARY OF THE INVENTION

A wireless cellular telecommunication system with an internet protocol network is provided. The wireless cellular telecommunication system comprises one or more base transceiver stations. The base transceiver stations can selectively provide radio resource management processing. The radio resource management processing can provide a means for performing an inter-base transceiver station handover. A base transceiver station can communicate with another base transceiver station for the handover processing without assistance from a centralized controller to perform control processing for said plurality of base transceiver stations. The base transceiver stations can further selectively provide management of a radio resource transmission between a mobile station and a mobile service switching center without assistance from a centralized controller to perform call control processing for the base transceiver stations. Radio resource management can further comprise management of the radio frequency resource.

According to an embodiment of the invention, the base transceiver stations can assign a radio channel to a mobile station for providing a connection between a base transceiver station and a mobile station. The assignment of a radio channel processing can be achieved without assistance from a centralized controller to perform control processing for the base transceiver stations.

According to another embodiment of the invention, the base transceiver stations can deallocate a radio channel to a mobile station for terminating a connection between a base transceiver station and a mobile station. The deallocation of a radio channel processing can be achieved without assistance from a centralized controller to perform control processing for the base transceiver stations.

According to another embodiment of the invention, the base transceiver stations can change a radio channel to a mobile station for communications between a mobile station and a base transceiver station. The change of a radio channel processing can be achieved without assistance from a centralized controller to perform control processing for the base transceiver stations.

According to another embodiment of the invention, the base transceiver stations can activate ciphering within a mobile station and the base transceiver stations. The activation of ciphering processing can be achieved without assistance from a centralized controller to perform control processing for the base transceiver stations.

According to another embodiment of the invention, the wireless cellular telecommunication system can further include a signaling router. The base transceiver stations can communicate with the mobile service switching center through the internet protocol network and the signaling router. The signaling router can establish signal system seven (SS7) over internet protocol connections with the base transceiver stations using signaling connection control part (SCCP) protocols. The signaling router can comprise a data store. The signaling router can populate the data store according to a given population scheme, such as a table format. For example, the signaling router can populate the table with SCCP protocols for the SS7 over internet protocol connections with the base transceiver stations to mask from the mobile switching center that there are SS7 and SCCP connections to each base transceiver station (i.e., the base station controller function is distributed across the base transceiver stations). The signaling router can use the signaling connection control part protocols stored in the table to route messages between the base transceiver stations and the mobile services switching center. The signaling router can be coupled to the internet protocol network through one or more SS7 over internet protocol links. Each SS7 over internet protocol link can be supported by a link card. For example, the signaling router can route messages from the base transceiver stations to the mobile services switching center through the SS7 over internet protocol links. Likewise, the signaling router can route messages from the mobile services switching center to the base transceiver stations through the SS7 over internet protocol links. Additionally, the signaling router can broadcast messages received from the mobile services switching center via the SCCP connectionless service to the base transceiver stations.

According to another embodiment of the invention, the mobile services switching center can be a distributed mobile services switching center. For example, the distributed mobile services switching center can provide public switched telephone network switching. However, the distributed mobile services switching center can also provide switching for the internet protocol network by distributing switching points across the internet protocol network.

According to another embodiment of the invention, the wireless cellular telecommunication system can also include a signaling gateway. The signaling gateway can communicate with the base transceiver stations and the mobile services switching center. The signaling gateway can be coupled to the internet protocol network through one or more signal system seven over internet protocol links. Each signal system seven over internet protocol links can be supported by a link card. For example, the signaling gateway can route messages from the mobile services switching center to the base transceiver stations through the signal system seven over internet protocol links. Likewise, the signaling gateway can route messages from the base transceiver stations to the mobile services switching center through the signal system seven over internet protocol links.

### BRIEF DESCRIPTION OF THE DRAWINGS

Embodiments will be described with reference to the following drawing figures, in which like numerals represent like items throughout the figures, and in which:

FIG. 1 is a block diagram showing the architecture of a GSM based wireless communications system.

FIG. 2 is a block diagram showing the circuit connections between hardware entities of the GSM wireless communications system of FIG. 1 for controlling two or more hardware entities for coordinating radio communications.

FIG. 3A-FIG. 3D are flow diagrams that are useful for understanding a radio resource management process.

FIG. 3E is a process flow diagram that is useful for understanding a handover procedure according to a conventional radio resource management procedure.

FIG. 4 is a block diagram of a GSM based wireless communications system with a base transceiver station having base station controller functionalities and a signaling router according to an embodiment of the invention.

FIG. 5 is a block diagram showing the circuit connections between hardware entities of the GSM based wireless communications system of FIG. 4 for controlling two or more hardware entities for coordinating radio communications.

FIG. 6A-FIG. 6D are flow diagrams that are useful for understanding radio resource management processes according to an embodiment of the invention.

FIG. 6E-FIG. 6G are flow diagrams that are useful for understanding handover procedures according to an embodiment of the invention.

FIG. 7 is a block diagram of a GSM based wireless communications system including a base transceiver station having base station controller functionalities and a distributed mobile service switching center according to an embodiment of the invention.

FIG. 8 is a block diagram of a GSM based wireless communications system including a base transceiver station having base station controller functionalities and a signaling gateway according to an embodiment of the invention.

### DETAILED DESCRIPTION OF THE PREFERRED EMBODIMENTS

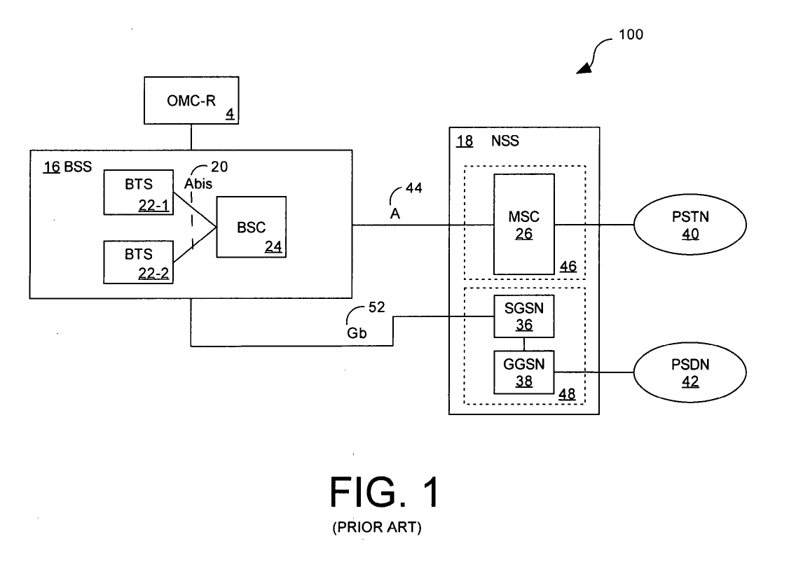

FIG. 1 is a block diagram showing the architecture of a conventional GSM based wireless communications system 100. The wireless communications system 100 includes several functional entities such as a base station subsystem 16, an operation and maintenance center for radio 4, a network switching subsystem 18, a public switched telephone network 40, and a public packet switched data network 42.

The base station subsystem 16 typically comprises base transceiver stations 22-1, 22-2 and a base station controller 24. The base transceiver stations 22-1, 22-2 typically comprise the equipment for transmitting and receiving radio signals, such as a transmitter, a receiver, and antennas. The base transceiver stations 22-1, 22-2 also include digital signal processing capabilities. The base transceiver stations 22-1, 22-2 typically receive and send signals to and from mobile stations. Upon receipt of a signal from a mobile station, the base transceiver station 22-1, 22-2 communicates the signal to the base station controller 24. The base station controller 24 is typically a centralized base station controller 24. The base station controller 24 performs control processing for a base station subsystem 16 having one or more base transceiver stations 22-1, 22-2. The signal communicated to the base station controller 24 typically includes signaling protocols for radio resource management.

Upon receipt of a signal with signaling protocols, the base station controller 24 can process the signaling protocols for radio resource management. The management of a radio resource transmission typically includes establishing a radio resource session. A radio resource session is established by controlling two or more hardware entities for coordinating radio communications. The hardware entities typically include a mobile station, a base transceiver station 22-1, 22-2, a centralized base station controller 24, and a mobile service switching center 26.

A radio resource management function typically includes management of the radio frequency resource, such as allocating radio channels to a mobile station, deallocating radio channels to a mobile station, changing radio channels to a mobile station, and activating ciphering (i.e. encryption and decryption) within a mobile station. For example, a base station controller 24 typically allocates a radio channel to a mobile station for providing a connection between a mobile station and a base transceiver station 22-1, 22-2. A base station controller 24 can deallocate a radio channel to a mobile station for terminating a connection between a mobile station and a base transceiver station 22-1, 22-2.

Radio resource management also includes inter-base station controller handover management, i.e., controlling a handover from one base transceiver station 22-1, 22-2 to another base transceiver station 22-1, 22-2. The radio resource management can be provided for one or more base transceiver stations 22-1, 22-2 supported by one or more centralized base station controllers 24. For example, an inter-base station controller handover can be processed between base transceiver stations 22-1, 22-2 managed by different centralized base station controllers 24.

The operation and maintenance center for radio 4 is conventionally a stand alone workstation responsible for operation and maintenance of the base station subsystem 16. The network switching subsystem 18 typically comprises a signal system seven (SS7) network 46 and an internet protocol network 48. The SS7 network 46 includes a mobile service switching center 26. The mobile service switching center 26 typically provides the call routing and roaming capabilities of the wireless communications system 100. The mobile service switching center 26 also typically provides a connection to the public switched telephone network 40.

The internet protocol network 48 typically allows for a given communication to be transmitted on a public packet switched data network 42. The internet protocol network 48 typically comprises a serving general packet radio service (GPRS) support node (SGSN) 36 and a gateway GPRS support node (GGSN) 38. The SGSN 36 typically includes hardware and software to determine the location of mobile stations, to store location information of mobile stations, to perform security functions, and to control access to the public packet switched data network 42. The SGSN 36 is coupled to the base station subsystem 16 through a Gb interface 52. The Gb interface typically relies on a frame relay protocol link between the base station controller 24 and the SGSN 36. The GGSN 38 typically provides a connection to the public packet switched data network 42 via an internet protocol link.

Circuit Connections for Establishing a Radio Resource Session

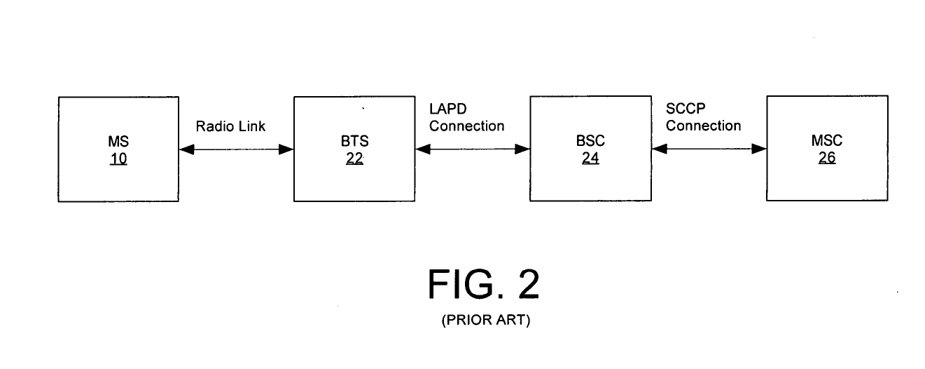

As mentioned above, radio resource management typically includes management of radio frequency transmissions. The management of a radio frequency transmission typically includes establishing a radio resource session. A radio resource session is established by controlling two or more hardware entities for performing radio resource management functions. FIG. 2 is a block diagram showing the circuit connections between hardware entities of the GSM wireless communications system of FIG. 1 for controlling two or more hardware entities for coordinating radio communications.

Referring now to FIG. 2, the hardware entities typically include a mobile station 10, a base transceiver station 22, a centralized base station controller 24, and a mobile service switching center 26. The mobile station 10 is typically coupled to the base transceiver station 22 through a radio link. The base transceiver station 22 is typically coupled to the base station controller 24 through a link access protocol (LAPD) connection. The base station controller is typically coupled to the mobile service switching center 26 through a signaling connection control part (SCCP) connection. The radio link, the LAPD connection, and the SCCP connection are well known to persons skilled in the art. Thus, these connections will not be described in great detail herein.

Radio Resource Management Procedures

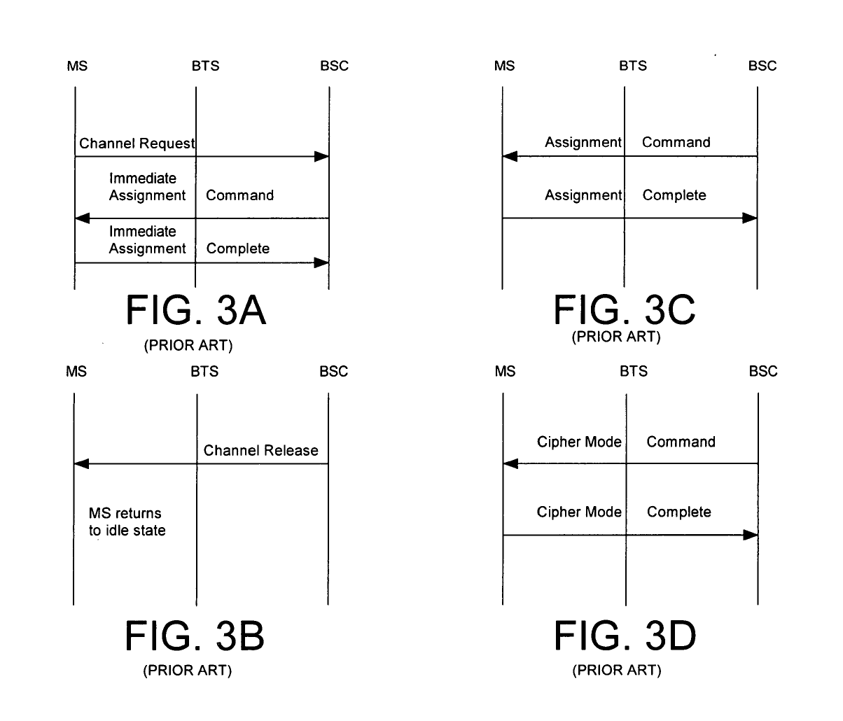

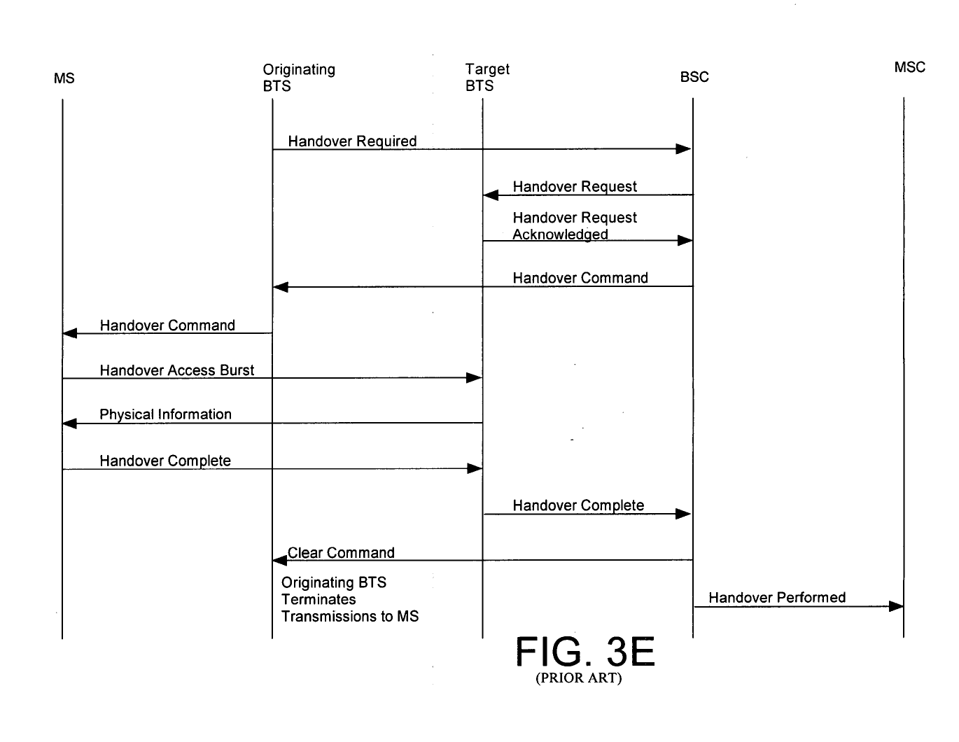

FIG. 3A-FIG. 3D are process flow diagrams for understanding conventional radio resource management processes. As mentioned above, radio resource management procedures typically handle the allocation of a radio channel to a mobile station, the deallocation of a radio channel to a mobile station, channel changes to a mobile station, and activation of ciphering within a mobile station.

FIG. 3A is a flow diagram illustrating an establishment of an allocation of a radio channel procedure within the conventional GSM based wireless communications system of FIG. 1. As shown in FIG. 3A, a mobile station 10 will send a ‘channel request’ message to a base station controller 24. Upon receipt of the ‘channel request’ message, ‘the base station controller 24 will send an ‘immediate assignment command’ message to the mobile station 10. This message typically includes radio channel information. Upon receipt of the ‘immediate assignment command’ message, the mobile station 10 will tune to the channel specified in the ‘immediate assignment command’ message. After tuning to the channel, the mobile station 10 will send an ‘immediate assignment complete’ message to the base station controller 24.

FIG. 3B is a flow diagram illustrating a deallocation of a radio channel procedure within the conventional GSM based wireless communications system of FIG. 1. As shown in FIG. 3B, the base station controller 24 will send a ‘channel release’ message to a mobile station 10 for terminating a radio resource connection. The base station controller 24 typically deallocates or releases a radio channel because a signaling procedure has been completed, an error has occurred, a higher priority call (such as an emergency call) requires use of the allocated channel, or a call is completed. Upon receipt of the ‘channel release’ message, the mobile station 10 will return to an idle state.

FIG. 3C is a flow diagram illustrating a channel change radio resource procedure. As shown in FIG. 3C, the base station controller 24 will send an ‘assignment command’ message to a mobile station 10 for changing the physical channel in use. The ‘assignment command’ message typically includes channel information for enabling the change of a radio channel within the mobile station 10. Upon receipt of the ‘assignment command’ message, the mobile station 10 typically suspends transmission of signaling messages. The mobile station 10 also typically terminates a connection to a base transceiver station 22-1, 22-2 and deactivates the old radio channel. After deactivating the old radio channel, the mobile station 10 typically tunes to the specified radio channel. This step involves activating a new physical radio channel, establishing a connection to a base transceiver station 22-1, 22-2 on the new radio channel, and discontinuing the suspension of signaling message transmissions. After the mobile station 10 tunes to the channel specified in the ‘assignment command’ message, the mobile station 10 will send an ‘assignment complete’ message to the base station controller 24.

FIG. 3D is a flow diagram illustrating an activation of ciphering radio resource procedure. As shown in FIG. 3D, the base station controller 24 will send a ‘cipher mode command’ message to a mobile station 10. This message typically indicates that the base station controller 24 has activated its deciphering function. Upon receipt of the ‘cipher mode command’ message, the mobile station 10 activates ciphering and deciphering functions. After activating the ciphering and deciphering functions, the mobile station 10 typically will send a ‘cipher mode complete’ message to the base station controller 24.

The foregoing descriptions of the radio resource management processes are useful for understanding conventional radio resource management processes. In this regard, a more detailed description of the various radio resource management procedures can be found in “GSM Switching, Services and Protocols” by Jorg Eberspacher, Hans-Jorg Vogel, and Christian Bettstetter, 2001 (ISBN: 0-47149903-X). The entire disclosure of this publication is incorporated herein by reference.

As mentioned above, radio resource management can also include handover processing. FIG. 3E is a process flow diagram of a conventional radio resource process including the exchange of signaling messages for performing a handover procedure. A handover typically is the switching of an on-going call between different base transceiver stations 22-1, 22-2. A handover typically occurs when transferring a call between (1) separate base transceiver stations 22-1, 22-2 that are under the control of a common base station controller 24, (2) base transceiver stations 22-1, 22-2 under the control of different base station controllers 24, where the base station controllers 24 are under the control of the same mobile service switching center 26, or (3) base transceiver stations 22-1, 22-2 under the control of separate base station controllers 24, where the base station controllers 24 are not under the control of the same mobile service switching center 26. Handovers usually occur when a mobile station 10 communicating through one base transceiver station 22-1, 22-2 moves from the coverage area of that base transceiver station 22-1, 22-2 to the coverage area of another base transceiver station 22-1, 22-2. To maintain the call, the mobile station 10 must transition from communicating with the current serving base transceiver station 22-1, 22-2 to communicating with the base transceiver station 22-1, 22-2 that the mobile station 10 is moving towards.

In order to identify when handover should occur and which base transceiver station 22-1, 22-2 the handover should be directed to, information is needed regarding the quality of the connection and signal power levels in adjacent base transceiver stations 22-1, 22-2. For example, in the wireless communication system known as GSM (Global System for Mobile Communications), each mobile station 10 monitors a power level and signal quality (downlink signal) from the base transceiver station 22-1, 22-2 that is currently serving the particular mobile station 10. The mobile station 10 also monitors downlink signal power levels for the neighboring base transceiver stations 22-1, 22-2. Conversely, the base transceiver stations 22-1, 22-2 also monitor the power levels and quality of uplink signals received from mobile stations 10 that it serves. The handover process can be triggered when this uplink or downlink monitoring indicates that low signal levels and/or poor signal quality exist in a current base transceiver station 22-1, 22-2, and it is determined that an improved link quality can be obtained from an adjacent base transceiver station 22-1, 22-2. Handover can also be initiated when the monitoring reveals that lower transmission power levels can be used for communications with a base transceiver station 22-1, 22-2 in a neighboring cell. Typically, this situation can arise when the mobile station 10 is in a boundary region between adjacent cells.

A handover process can include more or fewer steps depending on the type of handover. The following flow process example describes a handover process where the originating and target base transceiver stations 22-1, 22-2 are managed by the same base station controller 24. The message flow can be somewhat different where the base transceiver stations 22-1, 22-2 are managed by different base station controllers 24.

Referring now to FIG. 3E, an originating base transceiver station 22-1, 22-2 will send a ‘handover request’ message to base station controller 24. The base station controller 24 will forward the handover request to a target base transceiver station 22-1, 22-2 that is to begin serving a mobile station. This request will be acknowledged to the base station controller 24 by the target base transceiver station 22-1, 22-2. Thereafter the base station controller 24 will send a handover command message to the originating base transceiver station 22-1, 22-2. Once the handover command message is received by originating base transceiver station 22-1, 22-2, it will forward the handover command message to the mobile station. Thereafter, the mobile station will initiate a radio link with the target base transceiver station 22-1, 22-2. In particular, the mobile station will send a signal to the target base transceiver station 22-1, 22-2 to initiate the radio link. The target base transceiver station 22-1, 22-2 will respond by communicating assigned physical channel information to the mobile station. The mobile station will acknowledge this channel assignment by communicating to the target base transceiver station 22-1, 22-2 that the handover is complete. Target base transceiver station 22-1, 22-2 will forward this confirmation to the base station controller 24 which will communicate a command to the originating base transceiver station 22-1, 22-2 that it is no longer responsible for communicating with the mobile station. The base station controller 24 will also report to the mobile service switching center 26 that the handover is complete.

The foregoing descriptions of the radio resource management processes are useful for understanding conventional radio resource management processes. In this regard, a more detailed description of the various handover procedures can be found in “The GSM System for Mobile Communications” by Michel Mouly and Marie-Bernadette Pautet, 1992 (ISBN: 2-9507190-0-7). The entire disclosure of this publication is incorporated herein by reference.

GSM Architecture with a Distributed Base Station Controller

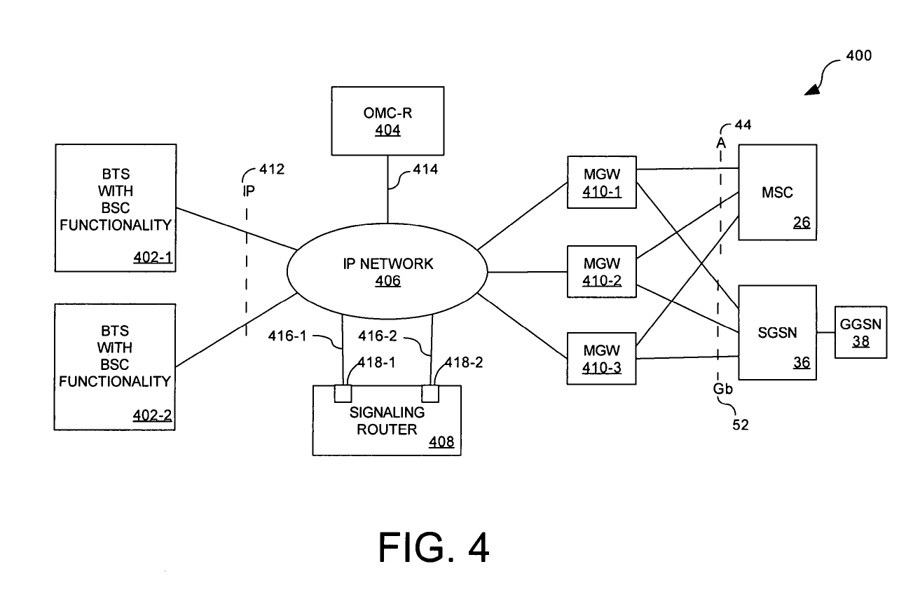

According to embodiments of the invention, a wireless communications system 100 architecture can be provided for implementing a base station subsystem 16 wherein the processing function of the base station controller 24 can be distributed among a number of base transceiver stations 22-1, 22-2. Such a wireless communications system can provide a more reliable communications system by eliminating a single point of failure (i.e. eliminating a centralized base station controller). Such as wireless communications system can also provide a scalable and flexible system for handling increasing mobile station 10 usage growth. The wireless communications system architectures, described below, can further provide systems that avoid excessive processing loads on a central base station controller 24. The wireless communications system architectures for implementing the base transceiver station having base station controller functionalities can require different hardware than that included in the wireless communications system 100 architecture of FIG. 1. Such wireless communications system architectures are illustrated in FIG. 4-FIG. 8.

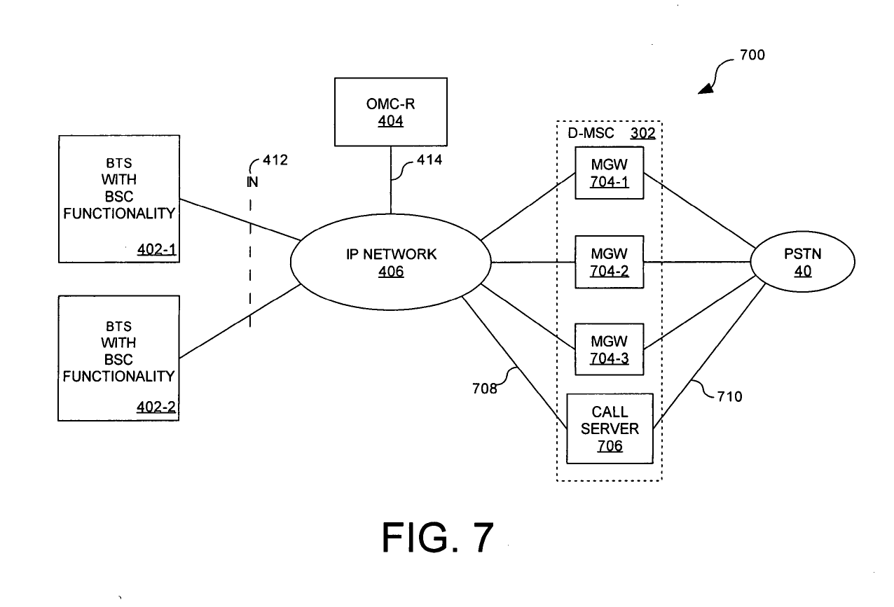

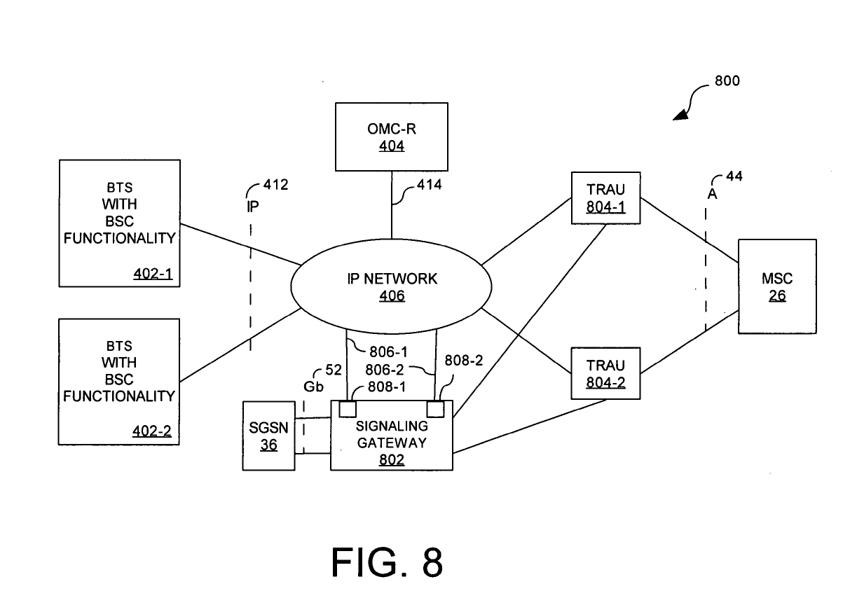

Notably, the wireless communications system architectures shown in FIG. 4, FIG. 7, and FIG. 8 can provide a scaleable wireless communications system. The wireless communications systems of FIG. 4, FIG. 7, and FIG. 8 can also provide a system for integrating traditional base station controller 24 functions into a base transceiver station, thus eliminating the need for a separate hardware component. The wireless communications systems of FIG. 4, FIG. 7, and FIG. 8 can also provide for a more direct connection between the base transceiver station and the mobile services switching center 26 by implementation of an all internet protocol network.

FIG. 4 is a block diagram of a GSM based wireless communications system 400 including base transceiver stations 402-1, 402-2. According to an embodiment of the invention, the wireless communications system 200 can comprise base transceiver stations 402-1, 402-2, an operation and maintenance center for radio 404, an internet protocol network (IP network) 406, a signaling router 408, media gateways (MGWs) 410-1, 410-2, 410-3, a mobile services switching center 26, a SGSN 36, and a GGSN 38. The base transceiver stations 402-1, 402-2 can include an antenna array, a receiver, and a transmitter. The base transceiver stations 402-1, 402-2 can also include a processor with a software program including instructions for providing radio resource management, which will be described in more detail below.

As mentioned above, a conventional base transceiver station 22-1, 22-2 typically comprises the equipment for transmitting and receiving radio signals, such as a transmitter, a receiver, and antennas. A conventional base transceiver station 22-1, 22-2 also includes signal processing capabilities. However, a conventional base transceiver station 22-1, 22-2 typically does not comprise a processor including a software program having instructions for providing radio resource management. In a conventional system, such a software program typically resides on a processor within a base station controller 24.

Referring again to FIG. 4, the base transceiver stations 402-1, 402-2 can control processing for radio resource management. Radio resource management can include management of a transmission between a mobile station and a mobile service switching center 26. Management of such a transmission can include controlling a mobile station, a base transceiver station 402-1, 402-2, and a mobile service switching center 26 to provide a suitable transmission means over a radio interface. Notably, the management of a transmission does not include controlling a conventional base station controller 24 to provide a suitable transmission means over a radio interface.

The base transceiver stations 402-1, 402-2 can assign a radio channel to a mobile station for providing a connection between the mobile station and a base transceiver station 402-1, 402-2. The base transceiver stations 402-1, 402-2 can deallocate a radio channel to a mobile station for terminating a connection between the mobile station and the base transceiver station 402-1, 402-2.

Radio resource management can also include inter-base transceiver station handover management. The base transceiver stations 402-1, 402-2 can include a processor with instructions for determining when to handover responsibilities for processing signals from a mobile station 10. The processor can further include instructions for determining which base transceiver station 402-1, 402-2 to handover responsibilities for processing signals from a mobile station 10. For example, radio resource management can include management of handover of responsibilities for processing signals from a mobile station 10 from a base transceiver station 402-1, 402-2 to another base transceiver station 402-1, 402-2. The radio resource management processing of a base transceiver station 402-1, 402-2 can be performed for one or more base transceiver stations 402-1, 402-2. For example, an inter-base transceiver station handover processing can be performed by one or more base transceiver stations 402-1, 402-2.

The base transceiver stations 402-1, 402-2 can provide radio resource management functions by directly communicating with another base transceiver station 402-1, 402-2. Communications between base transceiver stations 402-1, 402-2 can be performed by opening an internet protocol (IP) socket from one or more base transceiver stations 402-1, 402-2 (i.e. a base transceiver station 402-1, 402-2 can act as a client while another base transceiver station can act as a server). For example, a base transceiver station 402-1, 402-2 can communicate with another base transceiver station 402-1, 402-2 for an inter-base transceiver station handover processing through an internet protocol network. The transmission means can include controlling one or more base transceiver stations 402-1, 402-2 for providing management of an inter-base station controller handover. Notably, the management of a transmission means for performing an inter-base transceiver station 402-1, 402-2 handover does not include controlling a conventional base station controller 24 for providing management of an inter-base station controller handover.

Referring again to FIG. 4, the base transceiver stations 402-1, 402-2 can be coupled to the IP network 206 through an internet protocol interface 412. The interface 412 can enable the transmission of a signal with SS7 communications protocols for voice and/or circuit switched data (CSD) over the IP network 406. SS7 communications protocols are well known to persons skilled in the art. Thus, SS7 communications protocols will not be described in great detail herein. Also, methods for enabling the transmission of a signal with SS7 communications protocols over an IP network (SS7 over IP) are well known to persons skilled in the art. Thus, such methods will not be described in great detail herein.

The interface 412 can enable the transmission of a signal with SS7 communications protocols for voice and circuit switched data (CSD) between the base transceiver stations 402-1, 402-2 and other functional entities. For example, the base transceiver station 402-1, 402-2 can receive a signal with SS7 communications protocols for voice and CSD from a mobile station 10. Upon receipt of the signal, the base transceiver station 402-1, 402-2 can convert the signal to a signal with a SS7 over IP format for transmission over the interface 412. To convert the signal to a signal with a SS7 over IP format, the base transceiver station 402-1, 402-2 can break the signal into packets for transmission across the internet protocol interface 412. For example, a full rate (FR) voice data, enhanced full rate (EFR) voice data, adaptive multi-rate full rate (AMR FR) voice data, adaptive multi-rate half rate (AMR HR) voice data, and/or circuit switched data can be managed in packets of data. After the base transceiver station 402-1, 402-2 breaks the voice data and/or the circuit switched data into small packets, the base transceiver station 402-1, 402-2 can frame the packets with IP transport protocols. Then, the base transceiver station 402-1, 402-2 can send the resulting signal to a MGW 410-1, 410-2, 410-3 through the IP network 406. Likewise, each base transceiver station 402-1, 402-2 can send a signal for radio resource management directly to another base transceiver station 402-1, 402-2 through the IP network 406.

The operation and maintenance center for radio 404 can perform conventional operation and maintenance center for radio functions. However, the operation and maintenance center for radio 404 can be designed with a computer software and hardware architecture for implementation with an internet protocol network 406. For example, the operation and maintenance center for radio 404 can include a processor including a software routine for transmission of a signal over an internet protocol interface 414.

The signaling router 408 can be coupled to the IP network 406 through SS7 over IP links 416-1, 416-2. Although the wireless communications system 400 depicts two SS7 over IP links 416-1, 416-2, the wireless communications system 400 can comprise two or more of SS7 over IP links 416-1, 416-2. Each SS7 over IP link 416-1, 416-2 can be supported by a link card 418-1, 418-2. Each SS7 over IP link 416-1, 416-2 can provide a separate path for communicating messages between the signaling router 408 and each base transceiver station 402-1, 402-2 as well as the signaling router 408 and the mobile services switching center 26 via the MGWs 410-1, 410-2, 410-3. Similarly, each base transceiver station 402-1, 402-2 can support two SS7 over IP links (not shown) for redundancy. Likewise, the signaling router 408 can support two or more SS7 over IP links to the mobile services switching center 26 for redundancy. As a result, the signaling router's 408 routing capacity can be changed by adding or removing a link card 418-1, 418-2. The link cards 418-1, 418-2 can provide for redundancy. For example, the signaling router 408 can transmit and receive a signal through a SS7 over IP link 416-1. If a signal needs to be sent again, the signaling router 408 can switch to another SS7 over IP link 416-2 for retransmission of the signal.

According to an embodiment of the invention, the signaling router 408 can perform the routing functions of signaling for the wireless communications system 400 between the base transceiver stations 402-1, 402-2 and the mobile services switching center 26 for connection oriented messages associated with a specified call with a mobile station. Likewise, the signaling router 408 can route a signal with SS7 communications protocols for connectionless oriented messages from the mobile services switching center 26 to the base transceiver stations 402-1, 402-2 that are intended for base station subsystem management functions such as blocking, unblocking, and/or circuit reset as well as for paging messages through a MGW 410-1, 410-2, 410-3 and the IP network 406 and a SS7 over IP link 416-1, 416-2.

The signaling router 408 can also establish a SS7 connection with a base transceiver station 402-1, 402-2 using a signaling connection control part (SCCP) protocol. SCCP is a routing protocol for SS7. The signaling router 408 can comprise a data store, such as a RAM, ROM, or other storage device. After establishing a SS7 connection, the signaling router 408 can populate the data store with the SCCP according to a given population scheme, such as a table format. For example, the signaling router 408 can comprise a processor including a software program having instructions for populating the table with the SCCP for a SS7 connection between a base transceiver station 402-1, 402-2 and a mobile service switching center 26. Once the table is populated, the signaling router 408 can use the populated table in a message routing process. For example, the signaling router 408 can route a message between the base transceiver station 402-1, 402-2 and the mobile services switching center 26 using an SCCP stored in the table.

Concurrent with signaling between the base transceiver station 402-1, 402-2 and the mobile services switching center 26 through the signaling router 408, and the MGW 410-1, 410-2, 410-3, to establish or terminate a call, the base transceiver station 402-1, 402-2 can establish a direct connection to the MGW 410-1, 410-2, 410-3 for the transfer of voice or data traffic information. This direct connection may be supported by a number of IP data link protocols such as a real time protocol (RTP), a transfer control protocol (TCP), or a user datagram protocol (UDP). A signal transmitted across the IP network 406 between a base transceiver station 402-1, 402-2 and a MGW 410-1, 410-2, 410-3 can include small packets with FR voice data, EFR voice data, AMR FR voice data, AMR HR voice data, and/or CSD. The MGWs 410-1, 410-2, 410-3 can perform vocoding for FR voice data, EFR voice data, AMR FR voice data, AMR HR voice data to/from the pulse code modulation format (PCM) of the public switched telephone network 40, as well as providing support for CSD. The MGWs 410-1, 410-2, 410-3 can also convert a signal in a packet switched data format to an A interface 44 compatible with circuit switched T1/E1 line protocols. The MGWs 410-1, 410-2, 410-3 can further convert a signal with an internet protocol signaling format to a Gb interface 52 compatible signaling format such as a frame relay signaling format of the SGSN 36. The methods for converting a signal to an interface compatible format are well known to persons skilled in the art. Thus, the methods for performing the above mentioned MGW 410-1, 410-2, 410-3 signal conversions will not be described in great detail herein.

Those skilled in the art will appreciate that the system architecture illustrated in FIG. 4 is an embodiment of a wireless communications system 400 including a base transceiver station with base station controller functionalities. However, the invention is not limited in this regard and any other suitable wireless communications system including base transceiver station with base station controller functionalities can be used without limitation.

Circuit Connections for Establishing a Radio Resource Session

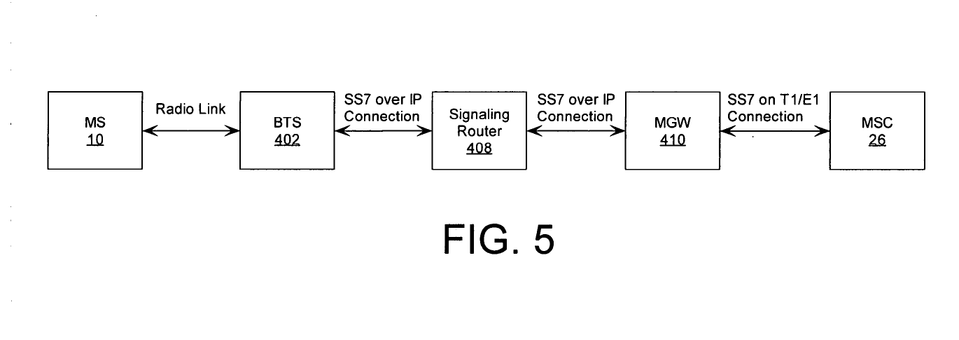

As mentioned above, radio resource management typically includes management of radio frequency transmissions. The management of a radio resource transmission typically includes establishing a radio resource session. A radio resource session is established by controlling two or more hardware entities for coordinating radio communications. FIG. 5 is a block diagram showing the circuit connections between hardware entities of the GSM wireless communications system of FIG. 4 for controlling two or more hardware entities for coordinating radio communications.

Referring now to FIG. 5, the hardware entities can include a mobile station 10, a base transceiver station 402, a signaling router 408, a MGW 410, and a mobile service switching center 26. The mobile station 10 can be coupled to the base transceiver station 402 through a radio link. The base transceiver station 402 can be coupled to the signaling router 408 through a SS7 over IP connection. The signaling router 408 can be coupled to the MGW 410 through a SS7 over IP connection. The MGW 410 can be coupled to the mobile service switching center 26 through a SS7 on T1/E1 connection. Notably, signaling flows through the signaling router 408 while traffic flows directly between the base transceiver station 402 and the MGW 410.

A radio link, a SS7 over IP connection, and a SS7 on T1/E1 connection are well known to persons skilled in the art. Thus, these connections will not be described in great detail herein.

Radio Resource Management Process

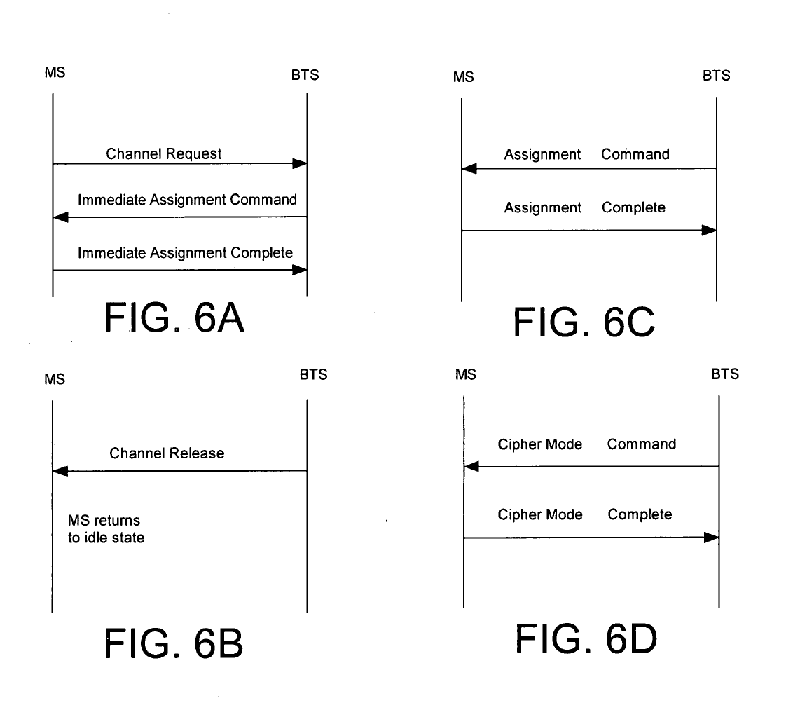

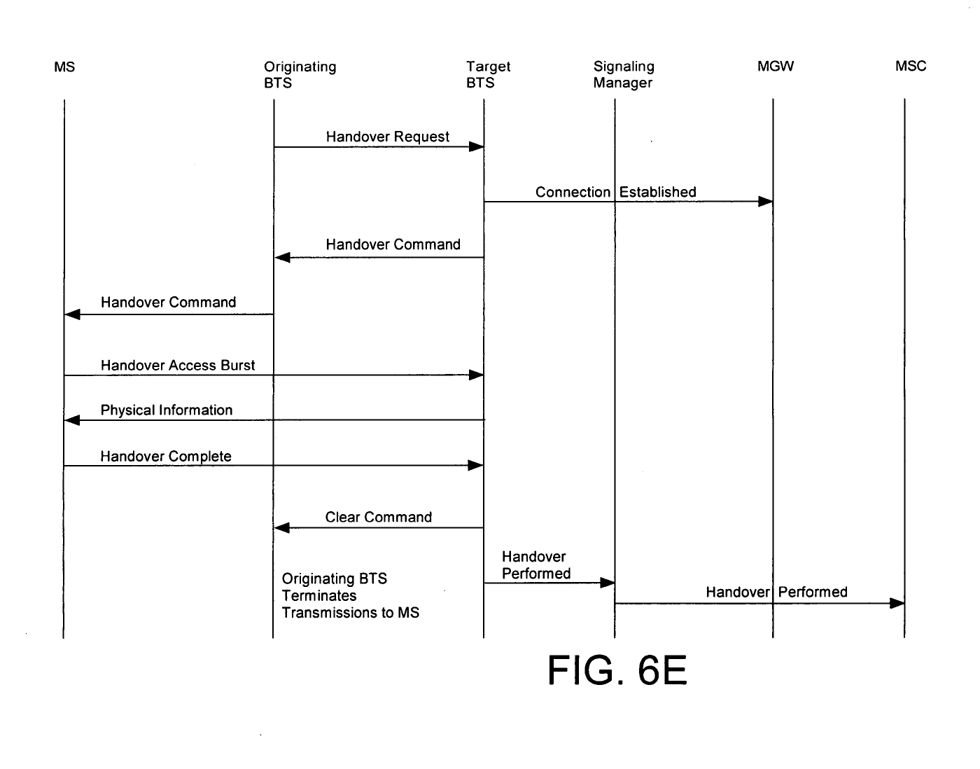

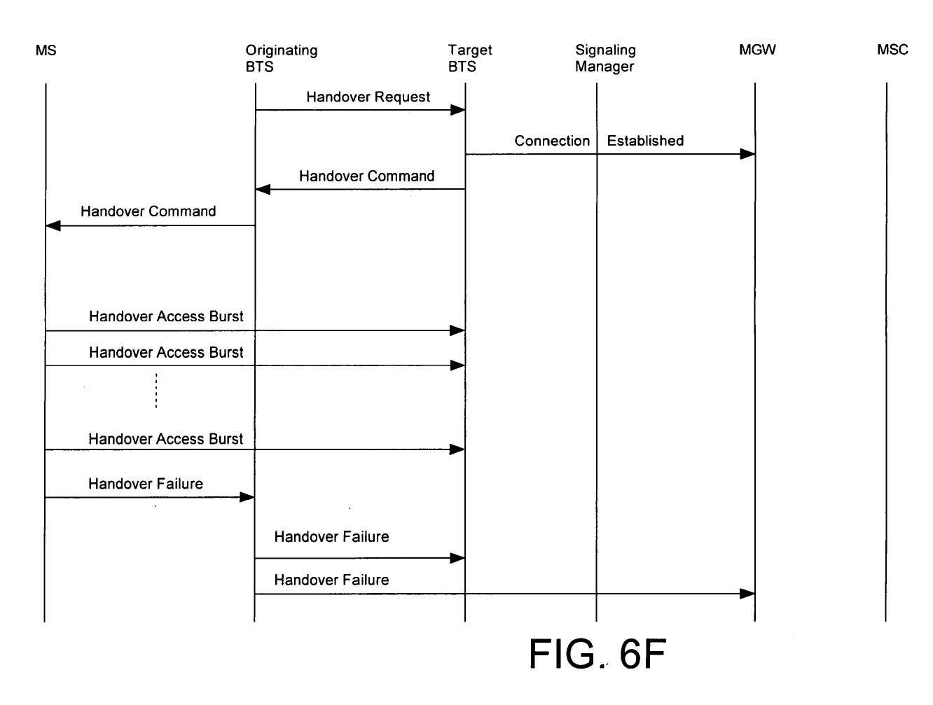

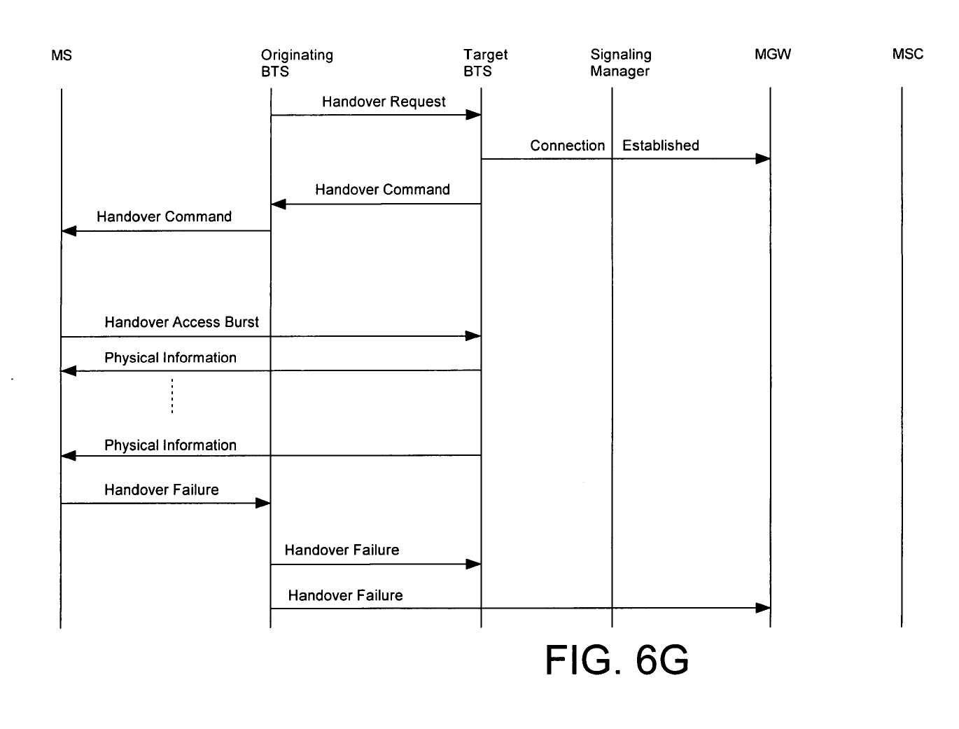

FIG. 6A-FIG. 6D are flow diagrams of radio resource management processes according to embodiments of the invention. As mentioned above, radio resource management procedures include the allocation of a radio channel to a mobile station, deallocation of a radio channel to a mobile station 10, and the administration of radio resources. Accordingly, radio resource management procedures are defined for setting up, maintaining, switching channels, and taking down of a radio resource connection. Such radio resource management procedures are illustrated in FIG. 6A-FIG. 6D.

FIG. 6A is a flow diagram illustrating an allocation of a radio channel within the wireless communications system of FIG. 4. As shown in FIG. 6A, a mobile station 10 can send a ‘channel request’ message to a base transceiver station 402-1, 402-2. Upon receipt of the ‘channel request’ message, ‘the base transceiver station 402-1, 402-2 can send an ‘immediate assignment command’ message to the mobile station 10. This message typically includes radio channel information. Upon receipt of the ‘immediate assignment command’ message, the mobile station 10 can tune to the channel specified in the ‘immediate assignment command’ message. After tuning to the channel, the mobile station 10 can send an ‘immediate assignment complete’ message to the base transceiver station 402-1, 402-2.

FIG. 6B is a flow diagram illustrating a deallocation of a radio channel within the wireless communications system of FIG. 4. As shown in FIG. 6B, the base transceiver station 402-1, 402-2 can send a ‘channel release’ message to a mobile station 10 for terminating a connection between the mobile station 10 and the base transceiver station 402-1, 402-2. Upon receipt of the ‘channel release’ message, the mobile station 10 can be placed in an idle state.

FIG. 6C is a flow diagram illustrating a channel change radio resource procedure. As shown in FIG. 6C, the base transceiver station 402-1, 402-2 can send an ‘assignment command’ message to a mobile station 10 for changing the physical channel in use. The ‘assignment command’ message can include channel information for enabling the change of a radio channel within the mobile station 10. Upon receipt of the ‘assignment command’ message, the mobile station 10 can suspend transmission of signaling messages. A connection to a base transceiver station 402-1, 402-2 can be terminated and the old radio channel can be deactivated. After deactivating the old radio channel, the mobile station 10 can tune to the specified radio channel. This step can involve activating a new physical radio channel, establishing a connection to a base transceiver station 402-1, 402-2 on the new radio channel, and discontinuing the suspension of signaling message transmissions. After the mobile station 10 tunes to the channel specified in the ‘assignment command’ message, the mobile station 10 can send an ‘assignment complete’ message to the base transceiver station 402-1, 402-2.

FIG. 6D is a flow diagram illustrating an activation of ciphering radio resource procedure. As shown in FIG. 6D, the base transceiver station 402-1, 402-2 can send a ‘cipher mode command’ message to a mobile station 10. This message can indicate that the base transceiver station 402-1, 402-2 has activated its deciphering function. Upon receipt of the ‘cipher mode command’ message, the mobile station 10 can activate ciphering and deciphering functions. After activating the ciphering and deciphering functions, the mobile station 10 can send a ‘cipher mode complete’ message to the base transceiver station 402-1, 402-2.

As mentioned above, radio resource management can include handover processing. FIG. 6E is a flow diagram of a handover process. A handover process can include more or fewer steps depending on the type of handover. The following flow process example describes a handover process between an originating base transceiver station 402-1, 402-2 to a target base transceiver station 402-1, 402-2.

Referring now to FIG. 6E, an originating base transceiver station 402-1, 402-2 2 can send a ‘handover request’ message to a target base transceiver station 402-1, 402-2 that is to begin serving a mobile station 10. The ‘handover request’ message can include information for establishing a connection with a MGW 410-1, 410-2, 410-3. For example, the target base transceiver station 402-1, 402-2 can determine if there is a radio channel available for the handover. If there is a radio channel available for a handover, the target base transceiver station 402-1, 402-2 can allocate a radio channel for establishing a connection with a mobile station 10. Thereafter, the target base transceiver station 402-1, 402-2 can send a message to the MGW 410-1, 410-2, 410-3 to establish a connection between the target base transceiver station 402-1, 402-2 and the MGW 410-1, 410-2, 410-3. After allocating a radio channel for establishing a connection with a mobile station 10, the target base transceiver station 402-1, 402-2 can send a ‘handover command’ message to the originating base transceiver station 402-1, 402-2. Once the handover command message is received by the originating base transceiver station 402-1, 402-2, it can forward the handover command message to the mobile station. Thereafter, the mobile station can initiate a radio link with the target base transceiver station 402-1, 402-2. In particular, the mobile station can send a signal to the target base transceiver station 402-1, 402-2 to initiate the radio link. The target base transceiver station 402-1, 402-2 can respond by communicating assigned physical channel information to the mobile station. The mobile station can acknowledge this channel assignment by communicating to the target base transceiver station 402-1, 402-2 that the handover is complete. The target base transceiver station 402-1, 402-2 can communicate a command to the originating base transceiver station 402-1, 402-2 that it is no longer responsible for communicating with the mobile station. Upon receipt of this command, the originating base transceiver station 402-1, 402-2 can deallocate the associated radio channel to terminate a connection with the MGW 410-1, 410-2, 410-3 for a handed over mobile station. The target base transceiver station 402-1, 402-2 can also report to the signaling router 408 that the handover is complete. The signaling router 408 can forward the report indicating that the handover is complete to the MGW 410-1, 410-2, 410-3.

A person skilled in the art will appreciate that a handover process of FIG. 6E is an embodiment of a handover process that can be performed by the GSM based wireless communications system 400. However, the invention is not limited in this regard and any other suitable handover process can be used without limitation.

FIG. 6F is a flow diagram of a radio resource management process according to an embodiment of the invention. As mentioned above, radio resource management can include a handover process. FIG. 6F illustrates the message flow for a handover failure because a target base transceiver station 402-1, 402-2 fails to detect a handover access from a mobile station.

As shown in FIG. 6F, an originating base transceiver station 402-1, 402-2 will send a ‘handover request’ message to a target base transceiver station 402-1, 402-2 that is to begin serving a mobile station 10. The ‘handover request’ message can include information for establishing a connection with a MGW 410-1, 410-2, 410-3. For example, the target base transceiver station 402-1, 402-2 can determine if there is a radio channel available for the handover. If there is a radio channel available for a handover, the target base transceiver station 402-1, 402-2 can allocate a radio channel for establishing a connection with a mobile station 10. Thereafter, the target base transceiver station 402-1, 402-2 can send a message to a MGW 410-1, 410-2, 410-3 to establish a connection between the target base transceiver station 402-1, 402-2 and the MGW 410-1, 410-2, 410-3. After allocating a radio channel for establishing a connection with a mobile station 10, the target base transceiver station 402-1, 402-2 can send a ‘handover command’ message to the originating base transceiver station 402-1, 402-2. Once the ‘handover command’ message is received by the originating base transceiver station 402-1, 402-2, it can forward the ‘handover command’ message to the mobile station 10. Upon receipt of the ‘handover command’ message, the mobile station 10 can send a ‘handover access’ message to the target base transceiver station 402-1, 402-2. If the mobile station 10 does not receive a response from the target base transceiver station 402-1, 402-2 within a pre-determined amount of time, the mobile station 10 can send another ‘handover access’ message to the target base transceiver station 402-1, 402-2. The mobile station 10 can repeat attempting to handover for a pre-determined number of times. After attempting a handover for a pre-determined number of times, the mobile station 10 can return to an originating base transceiver station 402-1, 402-2 and can send a ‘handover failure’ message. Upon receiving this message, the originating base transceiver station 402-1, 402-2 can forward the ‘handover failure’ message to the target base transceiver station 402-1, 402-2. The ‘handover failure’ message prompts the target base transceiver station 402-1, 402-2 to deallocate its radio channel for terminating its connection to the MGW 410-1, 410-2, 410-3. The originating base transceiver station 402-1, 402-2 can also forward the ‘handover failure’ message to the MGW 410-1, 410-2, 410-3 to switch connection back to the originating base transceiver station 402-1, 402-2.

A person skilled in the art will appreciate that a handover process of FIG. 6F is an embodiment of a handover process that can be performed by the GSM based wireless communications system 400. However, the invention is not limited in this regard and any other suitable handover process can be used without limitation.

FIG. 6G is flow diagram of a radio resource management process according to an embodiment of the invention. Specifically, FIG. 6G illustrates the message flow where the handover access is detected by a target base transceiver station 402-1, 402-2, but a mobile station does not receive a physical information message.

As shown in FIG. 6G, an originating base transceiver station 402-1, 402-2 can send a ‘handover request’ message to a target base transceiver station 402-1, 402-2 that is to begin serving a mobile station 10. The ‘handover request’ message can include information for establishing a connection with a MGW 410-1, 410-2, 410-3. For example, the target base transceiver station 402-1, 402-2 can determine if there is a radio channel available for the handover. If there is a radio channel available for a handover, the target base transceiver station 402-1, 402-2 can allocate a radio channel for establishing a connection with a mobile station 10. Thereafter, the target base transceiver station 402-1, 402-2 can send a message to the MGW410-1, 410-2, 410-3 to establish a connection between the target base transceiver station 402-1, 402-2 and the MGW 410-1, 410-2, 410-3. After allocating a radio channel for establishing a connection with a mobile station 10, the target base transceiver station 402-1, 402-2 can send a ‘handover command’ message to the originating base transceiver station 402-1, 402-2. Once the ‘handover command’ message is received by the originating base transceiver station 402-1, 402-2, it can forward the handover command message to the mobile station 10. Upon receipt of the ‘handover command’ message, the mobile station 10 can send a ‘handover access’ message to the target base transceiver station 402-1, 402-2. After receipt of the ‘handover access’ message, the target base transceiver station 402-1, 402-2 can send a ‘physical information’ message to the mobile station 10. If the target base transceiver station 402-1, 402-2 does not receive a ‘handover complete’ message from the mobile station 10 within a pre-determined amount of time, the target base transceiver station 402-1, 402-2 can send another ‘physical information’ message to the mobile station 10. The target base transceiver station 402-1, 402-2 can transmit this message for a pre-determined amount of times or until it receives a ‘handover complete’ message from the mobile station 10. If the mobile station 10 does not receive a ‘physical information’ message from the target base transceiver station 402-1, 402-2, the mobile station 10 can return to an originating base transceiver station 402-1, 402-2 and can send a ‘handover failure’ message. Upon receiving this message, the originating base transceiver station 402-1, 402-2 can send forward the ‘handover failure’ message to the target base transceiver station 402-1, 402-2. The ‘handover failure’ message prompts the target base transceiver station 402-1, 402-2 to deallocate its radio channel for terminating its connection to the MGW 410-1, 410-2, 410-3. The originating base transceiver station 402-1, 402-2 can also forward the ‘handover failure’ message to the MGW 410-1, 410-2, 410-3. Upon receipt of this message, the MGW 410-1, 410-2, 410-3 can switch connection back to the originating base transceiver station 402-1, 402-2.

A person skilled in the art will appreciate that a handover process of FIG. 6G is an embodiment of a handover process that can be performed by the GSM based wireless communications system 400. However, the invention is not limited in this regard and any other suitable handover process can be used without limitation.

Alternative GSM Architectures with a Distributed Base Station Controller

FIG. 7 is a block diagram of a GSM based wireless communications system 700 including a distributed mobile service switching center 702 and base transceiver stations 402-1, 402-2. The components of the wireless communications system 700 are generally similar to those of the wireless communications system 400, and thus, the description above will suffice with respect to the similar components. However, the wireless communications system 700 of FIG. 7 requires different hardware to implement a different wireless communications system architecture.

According to an embodiment of the invention, the wireless communications system 700 can comprise base transceiver stations 402-1, 402-2, an operation and maintenance center for radio 404, an IP network 406, a distributed mobile services switching center (MSC) 702, and a public switched telephone network 40. The distributed MSC 702 can provide switching functions for the public switched telephone network 40. The distributed MSC 702 can further provide switching for the IP network 406 by distributing switching points across the network (i.e. eliminates centralized switches). The distributed MSC 702 can provide a SS7 over IP signaling to or from the base transceiver stations 402-1, 402-2. The distributed MSC 702 can also provide a base transceiver station 402-1, 402-2 to base transceiver station 402-1, 402-2 radio resource processing for intra-network handovers.

The distributed MSC 702 can be implemented by distributing a combination of media gateways (MGWs) 704-1, 704-2, 704-3 and a call server 706. The MGWs 704-1, 704-2, 704-3 can provide voice and data bearer switching for the public switched telephone network 40. For example, a signal transmitted across the IP network 406 can include small packets with FR voice data, EFR voice data, AMR FR voice data, AMR HR voice data, and/or CSD. The MGWs 704-1, 704-2, 704-3 can perform vocoding for FR voice data, EFR voice data, AMR FR voice data, AMR HR voice data, as well as providing support for CSD.

The call server 706 can control the MGWs 704-1, 704-2, 704-3 and manage a signaling across the IP network 406 and the public switched telephone network 40. The call server 706 can be coupled to the IP network 406 through a SS7 over IP link 708. Although a single SS7 over IP link 708 is shown, the wireless communications system 700 can comprise one or more SS7 over IP links 708 from the call server 706 to the IP network 406.

Those skilled in the art will appreciate that the system architecture illustrated in FIG. 7 is an embodiment of a wireless communications system 700 including a distributed MSC and a base transceiver station with base station controller functionalities. However, the invention is not limited in this regard and any other suitable wireless communications system including a distributed MSC and a base transceiver station with base station controller functionalities can be used without limitation.

FIG. 8 is a block diagram of a GSM based wireless communications system 800 including base transceiver stations 402-1, 402-2 with conventional base station controller functionalities. The components of the wireless communications system 800 are generally similar to those of the wireless communications system 400, 700 and thus, the description above will suffice with respect to the similar components. However, the wireless communications system 800 of FIG. 8 requires different hardware to implement a different wireless communications system architecture.

According to an embodiment of the invention, the wireless communications system 800 can comprise base transceiver stations 402-1, 402-2, an operation and maintenance center for radio 404, an IP network 406, transcoding rate adaption units 804-1, 804-2, a mobile services switching center 26, a signaling gateway 802, and a serving GPRS support node 36. As described above, the base transceiver stations 402-1, 402-2 can include conventional base station controller functionalities. The processing of the base transceiver stations 402-1, 402-2 can be performed by one or more base transceiver stations 402-1, 402-2. The base transceiver stations 402-1, 402-2 can be coupled to the IP network 406 through an interface 412. As mentioned above, the interface 412 can provide a means for a signal with SS7 communications protocols transportation over an internet protocol network (SS7 over IP signaling).

The transcoding rate adaption units 804-1, 804-2 can compress and decompress voice data transmitted between the base transceiver stations 402-2, 402-2 and the mobile service switching center 26 or the serving GPRS support node 36. For example, a signal transmitted across the IP network 406 can include small packets with FR voice data, EFR voice data, AMR FR voice data, AMR HR voice data, and/or CSD. The transcoding rate adaption units 804-1, 804-2 can perform vocoding for FR voice data, EFR voice data, AMR FR voice data, AMR HR voice data, as well as providing support for CSD.

The signaling gateway 802 can be coupled to the IP network 406 through SS7 over IP links 806-1, 806-2. Although only two SS7 over IP links 806-1, 806-2 are shown in FIG. 8, the wireless communications system 800 can comprise one or more SS7 over IP links 806-1, 806-2. Each SS7 over IP link 806-1, 806-2 can be supported by a link card 808-1, 808-2. As a result, the signaling gateway's 802 routing capacity can be changed by adding or removing a link card 808-1, 808-2. Also, the link cards 808-1, 808-2 can provide for redundancy. For example, the signaling gateway 802 can transmit and receive a signal through a SS7 over IP link 806-1, 806-2. If a signal needs to be sent again, the signaling gateway 802 can switch to another SS7 over IP link 806-1, 806-2 for retransmission of the signal.

According to an embodiment of the invention, the signaling gateway 802 can manage a signaling across the IP network 806 by performing the routing functions of the wireless communications system 800. For example, the signaling gateway 802 can route a signal between the base transceiver stations 402-1, 402-2 and the mobile services switching center 26 through a SS7 over IP link 806-1, 806-2. Similarly, the signaling gateway 802 can route a signal between the base transceiver stations 402-1, 402-2 and the serving GPRS support node 36. The signaling gateway 802 can also route a signal with SS7 communications protocols for voice to a base transceiver station 402-1, 402-2 through a SS7 over IP link 806-1, 806-2 and the IP network 406. The signals sent to and from a base transceiver station 402-1, 402-2 can comprise protocols for paging, blocking, unblocking, and/or circuit reset.

Those skilled in the art will appreciate that the system architecture illustrated in FIG. 8 is an embodiment of a wireless communications system 800 including a base transceiver station with base station controller functionalities. However, the invention is not limited in this regard and any other suitable wireless communications system including a base transceiver station with base station controller functionalities can be used without limitation.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

What is claimed:

1. A method comprising:
receiving, at a target base transceiver station (BTS), a handover request message from an originating BTS, wherein said handover request message comprises information for establishing a mobile station connection with a media gateway;
allocating a radio channel in response to said radio channel being determined to be available for handover;
transmitting a connection established message to said media gateway;
transmitting a handover command message to said originating BTS, wherein said handover command message is forwarded to a mobile station by said originating BTS;
receiving, from said mobile station, an initiation signal configured to initiate a radio link;
transmitting assigned physical channel information to said mobile station in response to said initiation signal; and
receiving acknowledgment from said mobile station that said mobile station handover is complete.

2. The method of claim 1, further comprising transmitting a clear command to said originating BTS, wherein said originating BTS deallocates an associated radio channel in response to receiving said clear command and terminates an associated mobile station connection with said media gateway.

3. The method of claim 1, further comprising transmitting a handover complete message to a signaling manager, wherein said signaling manager forwards said handover complete message to said media gateway.

4. A method of radio resource management of a handover failure, the method comprising:
receiving, at a target base transceiver station (BTS), a handover request message from an originating BTS, wherein said handover request message comprises information for establishing a mobile station connection with a media gateway;
allocating a radio channel in response to said radio channel being determined to be available for handover;
transmitting a connection established message to said media gateway;
transmitting a handover command message to said originating BTS, wherein said originating BTS forwards said handover command message to said mobile station;
receiving a handover access message from said mobile station, wherein said mobile station is configured to retransmit said handover access message if said target BTS does not transmit a response;
receiving a handover failure message from said originating BTS that is forwarded from said mobile station; and
deallocating said radio channel intended for said mobile station.

5. The method of claim 4, wherein said originating BTS forwards said handover failure message to said media gateway in order to switch said mobile station connection back to said originating BTS.

6. The method of claim 4, wherein said mobile station is configured to retransmit said handover access message a predetermined number of times prior to generating said handover failure message.

7. A method of radio resource management of a handover failure, the method comprising:
receiving, at a target base transceiver station (BTS), a handover request message from an originating BTS, wherein said handover request message comprises information for establishing a mobile station connection with a media gateway;
allocating a radio channel in response to said radio channel being determined to be available for handover;
transmitting a connection established message to said media gateway;
transmitting a handover command message to said originating BTS, wherein said originating BTS forwards said handover command message to said mobile station; and
transmitting an assigned physical channel information to said mobile station in response to receiving a handover access message from said mobile station, wherein said target BTS is configured to retransmit said assigned physical channel information in response to said mobile station failing to transmit a handover complete message to said target BTS.

8. The method of claim 7, wherein said target BTS retransmits said assigned physical channel information a predetermined number of times if said mobile station fails to transmit a handover complete message to said target BTS.

9. The method of claim 7, wherein said mobile station transmits a handover failure message to said originating BTS in response to not receiving said assigned physical channel information from said target BTS.

10. The method of claim 9, wherein said originating BTS forwards said handover failure message to said media gateway, in order to switch said mobile station connection back to said originating BTS.
